(19) United States
(12) Patent Application Publication
(10) Pub. No.: US 2022/0115724 A1
(43) Pub. Date: Apr. 14, 2022

(54) STRETCHABLE ELECTROCHEMICAL CELL

(71) Applicant: The University of British Columbia, Vancouver (CA)

(72) Inventors: Tan Ngoc NGUYEN, Vancouver (CA); John David Wyndham MADDEN, Vancouver (CA); Mirza Saquib SARWAR, Vancouver (CA); Leanna K. HOGARTH, Port Moody (CA); Woohyuk LEE, Vancouver (CA)

(21) Appl. No.: 17/555,310

(22) Filed: Dec. 17, 2021

Related U.S. Application Data
(63) Continuation of application No. PCT/CA2020/050866, filed on Jun. 19, 2020.
(60) Provisional application No. 62/966,684, filed on Jan. 28, 2020.
(60) Provisional application No. 62/864,662, filed on Jun. 21, 2019.

(51) Int. Cl. H01M 50/136; H01M 50/449; H01M 50/155

(52) U.S. Cl. CPC H01M 50/136; H01M 2004/028; H01M 50/155; H01M 50/449

(57) ABSTRACT

Example embodiments of the described technology provide a stretchable electrochemical cell. The electrochemical cell may comprise an anode, a cathode, first and second current collectors electrically coupled to the anode and cathode respectively and a porous separator configured to carry an electrolyte solution. Components of the electrochemical cell may comprise a non-polar polymer or a polymer composition. Two adjacent components may comprise the same non-polar polymer or polymer composition. The electrochemical cell may also comprise an encapsulation at least partially enclosing components of the electrochemical cell.

### CROSS-REFERENCE TO RELATED APPLICATIONS

This application is a continuation of Patent Cooperation Treaty (PCT) application No. PCT/CA2020/050866 having an international filing date of 19 Jun. 2020, which in turn claims priority from, and for the purposes of the United States the benefit of 35 USC § 119 in connection with, U.S. Application No. 62/864,662 filed 21 Jun. 2019 and U.S. Application No. 62/966,684 filed 28 Jan. 2020. All of the applications referred to in this paragraph are hereby incorporated herein by reference.

### FIELD

The present disclosure relates to electrochemical cells and methods for fabrication and use of same. Some embodiments provide systems and methods useful in fabricating stretchable electrochemical cells.

### BACKGROUND

Electrochemical cells facilitate electrochemical reactions which produce electrical energy. The produced electrical energy may be utilized to power one or more electrical devices.

Within an electrochemical cell, ions flow between an anode to a cathode via an electrolyte solution loaded into a separator that is positioned between the anode and the cathode. Such ion flow is a result of oxidation and reduction reactions occurring at the anode and cathode respectively.

As an electrochemical cell is mechanically excited (e.g. bent, stretched, twisted, etc.) different layers of the electrochemical cell (e.g. anode, cathode, separator, etc.) may delaminate from one another. This may result in components of the cell being separated from one another (e.g. an anode may be separated from a current collector, a cathode may be separated from a current collector, etc.) thereby reducing electrical performance of the cell. This may also result in leakage of electrolyte solution from the electrochemical cell which may also reduce electrical performance of the cell and/or shorten a lifetime of the cell.

There is a need for improved electrochemical cells which are stretchable, bendable and/or twistable. There is also a need for improved components of electrochemical cells which may be incorporated into a stretchable electrochemical cell.

### SUMMARY

Further aspects and example embodiments are illustrated in the accompanying drawings and/or described in the following description.

One example aspect of the technology described herein provides a stretchable electrochemical cell. The cell may comprise: an anode; a cathode; an ionically permeable separator positioned between the anode and the cathode; a first current collector electrically coupled to the anode; and a second current collector electrically coupled to the cathode. At least two adjacent components of the cell may each comprise at least one non-polar polymer that is common to both of the at least two adjacent components. The at least one common non-polar polymer may at least partially be entangled across an interface formed between adjacent surfaces of the at least two adjacent components.

The cell may further comprise an encapsulation. The encapsulation may at least partially enclose the anode, cathode, separator and first and second current collectors.

Three or more components of the cell may comprise at least one common non-polar polymer.

All components of the cell may comprise at least one common non-polar polymer.

The at least one common non-polar polymer may comprise a single type of repeating unit.

The at least one common non-polar polymer may comprise a plurality of types of repeating units.

The at least one common non-polar polymer may have a moisture permeability of less than 80×10-10 cm³·cm/(cm²·s·cmHg)±10%.

The at least one common non-polar polymer may comprise a polymer from the group consisting of: poly(styrene—isobutylene—styrene); poly(styrene-isoprene-styrene); poly(styrene-butadiene-styrene); Ecoflex™; polydimethylsiloxane; poly(ethylene-vinyl acetate); polyurethane; butyl rubber; hydrogenated nitrile butadiene rubber; and polyethylene.

The at least one common non-polar polymer may comprise poly(styrene—isobutylene—styrene) (SIBS).

One or more components of the cell may comprise at least one polymer from the group consisting of: poly(styrene—isobutylene—styrene); poly(styrene-isoprene-styrene); poly(styrene-butadiene-styrene); Ecoflex™; polydimethylsiloxane; poly(ethylene-vinyl acetate); polyurethane; butyl rubber; hydrogenated nitrile butadiene rubber; and polyethylene.

The encapsulation may comprise at least one polymer from the group consisting of: poly(styrene—isobutylene—styrene); poly (ethylene-vinyl acetate); butyl rubber; hydrogenated nitrile butadiene rubber; and polyethylene.

One or both of the first and second current collectors may comprise a non-polar polymer and at least one carbon-based material.

The at least one carbon-based material may comprise at least one carbon allotrope.

The at least one carbon allotrope may comprise one or more of the group consisting of: graphite; graphene; carbon powders; acetylene black; carbon nanotubes; and carbon nanofibers.

One or both of the first and second current collectors may comprise SIBS and carbon black powder.

One or both of the first and second current collectors may further comprise a carbon allotrope having a tensile strength of at least 5 GPa±10%.

One or both of the first and second current collectors may further comprise carbon nanofibers.

One or both of the first and second current collectors may comprise 4 parts carbon black powder to 10 parts SIBS and 1 part carbon nanofibers to 10 parts SIBS.

One or both of the first and second current collectors may have a conductivity greater than 230 S/m±10%.

One or both of the first and second current collectors may have a stretchability greater than 100% strain±10%.

One or both of the first and second current collectors may comprise a copper layer covering at least a portion of a surface of the first and/or second current collector.

The copper layer may have a thickness of between 0.1 and 10 μm.

One or both of the first and second current collectors may extend longitudinally outwardly.

One or both of the anode and the cathode may comprise one or more from the group consisting of: lithium; sodium; potassium; silicon; germanium; aluminum; magnesium; zinc; gallium; arsenic; silver; indium; tin; lead; and bismuth.

The anode may comprise zinc (Zn).

The cathode may comprises MnO₂.

The separator may comprise a plurality of pores.

The pores may have a diameter in the range between 1 to 5 μm.

The separator may comprise SIBS.

The separator may comprise an electrolyte solution.

The electrolyte solution may comprise ZnSO₄ and MnSO₄.

The electrolyte solution may comprise a solution comprising 2M±10% ZnSO₄+0.2M±10% MnSO₄.

The encapsulation may comprise SIBS.

The encapsulation may comprise a plurality of bonded layers.

The plurality of bonded layers may comprise at least a first layer and a second layer. The first current collector may be coupled to the first layer. The second current collector may be coupled to the second layer.

The encapsulation may comprise a three-dimensional structure.

The cell may have a thickness of less than 1 mm±10%.

The cell may have a thickness of less than 0.5 mm±10%.

The cell may be embeddable in a garment.

The cell may be repeatedly washable. The cell may be washable at least 23 times. The cell may be washable at least 70 times.

The cell may have an operable temperature range from −20° C. to 50° C.

The cell may have a shelf-life of at least six months.

The cell may have an electrolyte evaporation rate of less than 7%±10% for at least six months.

The cell may be rechargeable.

The cell may be self-chargeable.

The cell may be rechargeable by applying a plurality of mechanical excitations to the cell. The plurality of mechanical excitations may comprise at least one of stretching the cell, bending the cell and twisting the cell.

The cell may have at least a 75%±10% retention capacity after 500 charge and discharge cycles.

The cell may have a reversible specific capacity of 160 mAH/g±10%.

The cell may have an operating voltage between 0.8V and 1.8V.

The cell may have a voltage rating of 1.5V.

The cell may have a current rating of 10 mAh/cm².

The cell may have a current rating between 3 mAh/cm² and 5 mAh/cm².

Another example aspect of the technology described herein provides a method of fabricating an electrochemical cell described herein. The method may comprise dissolving the at least one common non-polar polymer at least partially along an interface formed between adjacent surfaces of the at least two adjacent components with a solution to bond the at least two adjacent components together.

The solution may comprise a solvent which dissolves the common non-polar polymer. The solvent may comprise toluene.

The solution may comprise the common non-polar polymer.

The solution may comprise SIBS.

The method may further comprise fabricating the separator by using a phase separation method.

The phase separation method may comprise a solvent evaporation induced phase separation (SIPS) method.

The SIPS method may comprise: dissolving a polymer in a solution comprising a solvent and a nonsolvent; evaporating the solvent from the solution; growing and coalescencing nonsolvent-rich droplets; and removing the nonsolvent droplets.

The solvent may have a higher evaporation rate than the nonsolvent.

The polymer may comprise SIBS.

The solvent may comprise one or more of the group consisting of: toluene; chloroform; dichloromethane; and trichloroethylene.

The solvent may comprise toluene.

The solution may comprise one part SIBS to 10 parts toluene.

The nonsolvent may comprise one or more of the group consisting of: hexane; acetone; butanol; 2-propanol; tetrahydrofuran (THF); dimethyl sulfoxide (DMSO); methanol and water.

The nonsolvent may comprise DMSO.

The method may further comprise casting the solution on a substrate. The solution may be cast by doctor blading. The solution may be cast by drop casting.

The method may further comprise fabricating one or both of the current collectors by casting a current collector paste on a substrate.

The current collector paste may comprise SIBS dissolved in toluene, carbon black and carbon nanofibers.

The current collector paste may be cast by doctor blading. The current collector paste may be cast by stencil printing.

The method may further comprise fabricating the anode by depositing metal particles over at least a portion of a surface of the first current collector.

The metal particles may be deposited by at least one process from the group consisting of: doctor blading; electroplating; and electrospinning.

The method may further comprise fabricating the cathode by depositing metal oxide, polyanionic compound or cyanoferrate particles over at least a portion of a surface of the second current collector. The particles may be deposited by at least one process from the group consisting of doctor blading and electroplating.

The method may further comprise fabricating one or more layers of the encapsulation by casting the one or more layers.

The method may further comprise fabricating one or more layers of the encapsulation by hot pressing the one or more layers.

The method may further comprise fabricating the encapsulation by heat pressing a three dimensional structure.

Another example aspect of the technology described herein provides a method of fabricating a porous separator. The method may comprise: dissolving a polymer in a solution comprising a solvent and a nonsolvent; evaporating the solvent from the solution; growing and coalescencing nonsolvent-rich droplets; and removing the nonsolvent droplets.

The solvent may have a higher evaporation rate than the nonsolvent.

The polymer may comprise SIBS.

The solvent may comprise one or more of the group consisting of: toluene; chloroform; dichloromethane; and trichloroethylene.

The solvent may comprise toluene.

The solution may comprise one part SIBS to 10 parts toluene.

The nonsolvent may comprise one or more of the group consisting of: hexane; acetone; butanol; 2-propanol; tetrahydrofuran (THF); dimethyl sulfoxide (DMSO); methanol and water.

The nonsolvent may comprise DMSO.

The method may further comprise casting the solution on a substrate. The solution may be cast by doctor blading. The solution may be cast by drop casting.

Another example aspect of the technology described herein provides a stretchable conductor. The conductor may comprise a non-polar polymer and at least one carbon-based material.

The at least one carbon-based material may comprise at least one carbon allotrope.

The at least one carbon allotrope may comprise one or more of the group consisting of: graphite; graphene; carbon powders; acetylene black; carbon nanotubes; and carbon nanofibers.

The conductor may comprise SIBS and carbon black powder.

The conductor may comprise a carbon allotrope having a tensile strength of at least 5 GPa±10%.

The conductor may comprise carbon nanofibers.

The conductor may comprise 4 parts carbon black powder to 10 parts SIBS and 1 part carbon nanofibers to 10 parts SIBS.

The conductor may have a conductivity greater than 230 S/m±10%.

The conductor may have a stretchability greater than 100% strain±10%.

The conductor may further comprise a copper layer covering at least a portion of a surface of the conductor.

The copper layer may have a thickness of between 0.1 and 10 μm.

Another example aspect of the technology described herein provides a stretchable electrochemical cell. The cell may comprise: an anode; a cathode; an ionically permeable separator positioned between the anode and the cathode; a first current collector electrically coupled to the anode; and a second current collector electrically coupled to the cathode. At least two adjacent components of the cell may each comprise at least one polymer composition that is common to both of the at least two adjacent components. The at least one common polymer composition may comprise at least one polymer. The polymer may at least partially be entangled across an interface formed between adjacent surfaces of the at least two adjacent components.

The cell may further comprise an encapsulation. The encapsulation may at least partially enclose the anode, cathode, separator and first and second current collectors.

Three or more components of the cell may comprise at least once common polymer composition.

All components of the cell may comprise at least one common polymer composition.

The at least one polymer of the polymer composition may comprise a polymer having an elongation at break that is greater than a threshold value.

The threshold value may be 100% strain. The threshold value may be 50% strain.

The common polymer composition may comprise at least one additive from the group consisting of: Polyvinylidene Chloride (“PVDC”); Low-Density Polyethylene (“LDPE”); Polypropylene (“PP”); Polytetrafluoroethylene (“PTFE”); Polyvinyl Chloride (“PVC”); Fluorinated ethylene propylene (“FEP”); Polyethylene Naphthalate (“PEN”); Graphene; reduced-Graphene Oxide (“rGO”); clay; and a clay-based material.

Another example aspect of the technology described herein provides a method for detecting a mechanical excitation. The method may comprise, by using any electrochemical cell described elsewhere herein: repeatedly measuring an open circuit voltage of the electrochemical cell; determining a baseline open circuit voltage of the electrochemical cell; identifying a drop in the open circuit voltage; and correlating the drop in the open circuit voltage to a magnitude of the mechanical excitation.

The mechanical excitation may be bending of the electrochemical cell. The mechanical excitation may be stretching of the electrochemical cell.

Correlating the drop in the open circuit voltage to the magnitude of the mechanical excitation may comprise correlating the drop in the open circuit voltage to a percentage strain of the electrochemical cell.

The open circuit voltage of the cell may be measured continuously.

Identifying the drop in the open circuit voltage may comprise identifying an open circuit voltage that is less than the baseline open circuit voltage by at least a threshold voltage amount.

The threshold voltage amount may be between 0.1 mV and 10 mV. The threshold voltage amount may be between 0.1 mV and 20 mV.

Identifying the drop in the open circuit voltage may comprise identifying a recovery of the open circuit voltage to the baseline open circuit voltage within a set amount of time.

The set amount of time may be less than 250 seconds. The set amount of time may be less than 150 seconds.

Another example aspect of the technology described herein provides a method for recharging any electrochemical cell described elsewhere herein. The method may comprise subjecting the electrochemical cell to a plurality of mechanical excitations.

At least one of the plurality of mechanical excitations may comprise stretching the electrochemical cell. At least one of the plurality of mechanical excitations may comprise bending the electrochemical cell. At least one of the plurality of mechanical excitations may comprise twisting the electrochemical cell.

An accumulated level of charge of the electrochemical cell may increase when the plurality of mechanical excitations comprises less than 20 excitations.

An accumulated level of charge of the electrochemical cell may increase when the plurality of mechanical excitations comprises less than 10 excitations.

The accumulated charge may sustain a continuous discharge of the electrochemical cell for an amount of time between 1 second and 250 seconds.

The electrochemical cell may be discharged with a current less than 0.5 mA.

The electrochemical cell may be discharged with a 0.2 mA current.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1A is a schematic perspective view of an electrochemical cell according to an example embodiment of the invention.

FIG. 1B is a schematic cross-sectional view of the electrochemical cell of FIG. 1A.

FIG. 1C is a schematic diagram showing an example load coupled to the electrochemical cell of FIG. 1A.

FIG. 2 is a graphical illustration of example Young's moduli of poly(styrene—isobutylene—styrene) (“SIBS”) substrate, an example conductor comprising carbon black powder and an example conductor comprising carbon black powder and carbon nanofibers according to an example embodiment of the invention.

FIG. 3 is a block diagram illustrating a method according to an example embodiment of the invention.

FIGS. 4A to 4C are graphical illustrations of properties of a conductor according to an example embodiment of the invention.

FIG. 5 is a block diagram illustrating a method according to an example embodiment of the invention.

FIGS. 6A and 6B are schematic illustrations of example steps of the method of FIG. 5.

FIG. 7 is a block diagram illustrating a method according to an example embodiment of the invention.

FIGS. 8A and 8B are schematic illustrations of example steps of the method of FIG. 7.

FIG. 9 is a block diagram illustrating a method according to an example embodiment of the invention.

FIG. 10 is a schematic illustration of example steps of the method of FIG. 9.

FIG. 11 is a schematic illustration of example stages in the formation of a separator according to an example embodiment.

FIG. 12 is a ternary phase diagram illustrating an example evolution of compositions within a separator during formation of the separator.

FIG. 13 is a graphical illustration of conductivity of an example separator formed according to the method of FIG. 9.

FIG. 14 is a schematic illustration of an encapsulation according to an example embodiment of the invention.

FIGS. 15A to 15F are graphical illustrations of example performance parameters of an electrochemical cell according to an example embodiment of the invention.

FIG. 16 is a graphical illustration of discharge capacity of an example unwashed cell and a cell that has been repeatedly washed.

FIG. 17A is a graphical illustration of an open circuit voltage response of an example cell.

FIG. 17B is a graphical illustration of peaked voltage responses as an example cell is bent in a plurality of directions.

FIG. 18 is a schematic exploded cross-sectional view of an electrochemical cell according to an example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the invention described herein provides a stretchable and/or flexible electrochemical cell having improved performance characteristics. The cell comprises an anode, a cathode, a pair of current collectors electrically coupled to the anode and cathode (e.g. each current collector is electrically coupled to one of the anode and the cathode) and a porous separator. The porous separator may be designed to carry an electrolyte solution and act as an ionic membrane. Such components of the cell may comprise a non-polar polymer. Different components of the cell may comprise the same or different non-polar polymers. Some components may comprise a plurality of non-polar polymers. Each of the plurality of non-polar polymers may be miscible with other polymers in the plurality (e.g. by physical mixing, solution blending, etc.). However, in some embodiments, at least two adjacent components of the cell (e.g. a current collector and the anode, the anode and the separator, the separator and the cathode, the cathode and a current collector, etc.) both comprise at least one common non-polar polymer.

In some embodiments a non-polar polymer described herein comprises a single type of repeating unit (e.g. such non-polar polymer may be referred to as a “homopolymer” in the art). In some such embodiments the non-polar polymer comprises a hydrocarbon chain. In some embodiments a non-polar polymer described herein comprises a plurality of types of repeating units (e.g. such non-polar polymer may be referred to as a “copolymer” in the art). In some such embodiments the non-polar polymer comprises a high (e.g. greater than about 50%) hydrocarbon ratio. In some embodiments, this hydrocarbon ratio is greater than 30%.

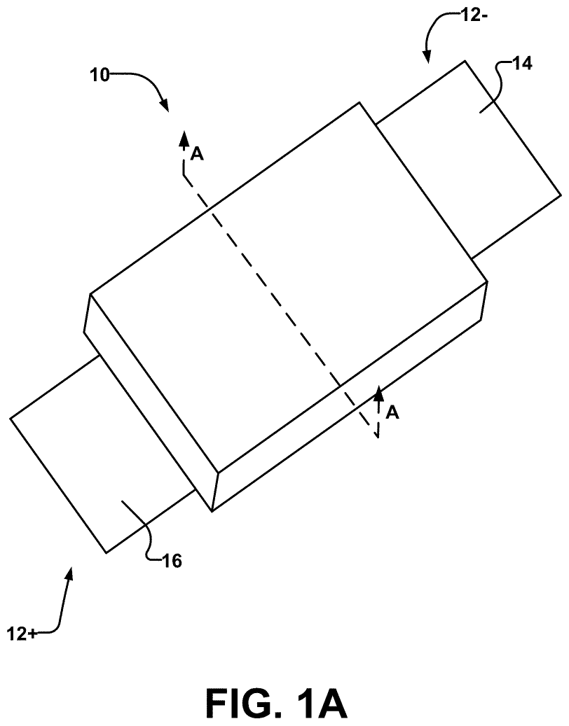

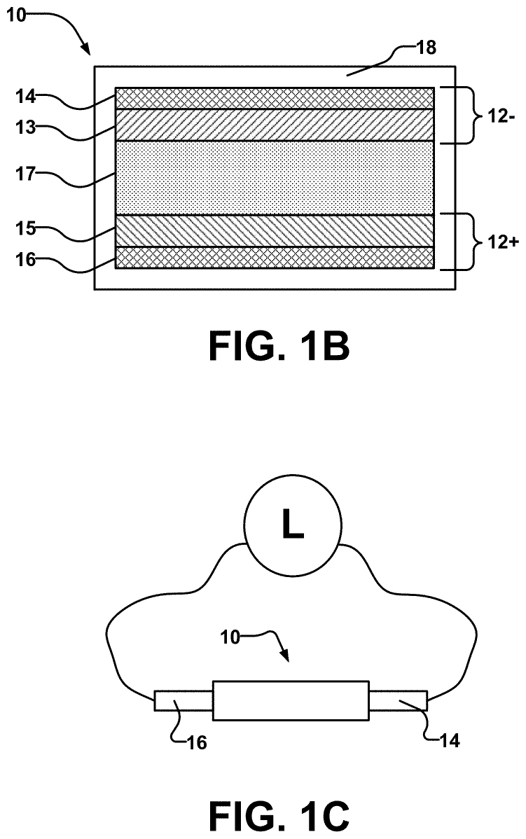

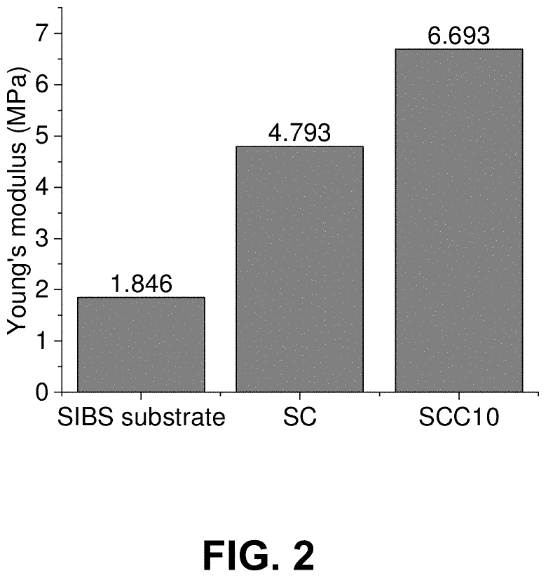

FIG. 1A is a perspective view of an example stretchable electrochemical cell 10. FIG. 1B is a schematic cross-sectional view of cell 10 along the plane indicated by line A-A of FIG. 1A.

As shown in FIG. 1B, cell 10 comprises a pair of electrodes 12− and 12+ (collectively electrodes 12). Electrode 12− (e.g. a “negative electrode”) comprises anode 13 and a current collector 14 electrically coupled to anode 13. Electrode 12+(e.g. a “positive electrode”) comprises cathode 15 and a current collector 16 electrically coupled to cathode 15. A porous separator 17 is positioned between anode 13 and cathode 15. Porous separator 17 may carry an electrolyte solution facilitating ionic flow between anode 13 and cathode 15. An encapsulation layer 18 at least partially encloses electrodes 12 and separator 17.

Components of cell 10 (e.g. anode 13, cathode 15, current collectors 14 and 16, separator 17, encapsulation 18) may comprise one or more non-polar polymers from the group consisting of: poly(styrene—isobutylene—styrene) (“SIBS”); poly(styrene-isoprene-styrene) (“SIS”); poly(styrene-butadiene-styrene) (“SBS”); Ecoflex™; polydimethylsiloxane (“PDMS”); poly (ethylene-vinyl acetate) (EVA); polyurethane (“PU”); butyl rubber; hydrogenated nitrile butadiene rubber (“HNBR”); polyethylene (“PE”) and/or the like.

In preferred embodiments encapsulation 18 comprises one or more non-polar polymers having a low moisture permeability (e.g. less than about 80×10⁻¹⁰ cm³·cm/(cm²·s·cmHg) at 40° C.). This low moisture permeability may advantageously reduce the likelihood and/or amount of leakage of electrolyte solution from cell 10, thereby extending the life of cell 10. In some embodiments encapsulation 18 comprises a non-polar polymer comprising a hydrocarbon chain or a high (e.g. greater than about 50%) hydrocarbon ratio. In some embodiments, this hydrocarbon ratio is greater than about 30%. In some embodiments encapsulation 18 comprises one or more non-polar polymers from the group consisting of: poly(styrene—isobutylene—styrene) (“SIBS”); poly (ethylene-vinyl acetate) (EVA); butyl rubber; hydrogenated nitrile butadiene rubber (“HNBR”); and polyethylene (“PE”).

In some embodiments, at least two adjacent components (e.g. current collector 14 and anode 13, anode 13 and separator 17, separator 17 and cathode 15, cathode 15 and current collector 16, current collector 16 and encapsulation 18, current collector 14 and encapsulation 18, separator 17 and encapsulation 18, etc.) of cell 10 comprise a common non-polar polymer. By incorporating a common non-polar polymer into the at least two adjacent components of cell 10, the inventors have discovered that the at least two adjacent components of cell 10 may have a matching (or uniform) response to a mechanical excitation (such as bending, twisting, stretching, etc.) of cell 10. For example, the inventors have discovered that the delamination (which may result in leaking of electrolyte, reduced electrical contact between adjacent layers, other performance and/or lifetime reducing effects, and/or the like) of the at least two adjacent layers can be eliminated (or mitigated) if the at least two adjacent layers comprise a common non-polar polymer.

In some embodiments three or more of the components (e.g. three or more of anode 13, current collector 14, cathode 15, current collector 16, separator 17 and encapsulation 18) comprise a common non-polar polymer. In some embodiments all components (e.g. anode 13, current collector 14, cathode 15, current collector 16, separator 17 and encapsulation 18) of cell 10 comprise a common non-polar polymer. In such embodiments all of the components of cell 10 may have a matching (or uniform) response to a mechanical excitation of cell 10. Advantageously, this may completely eliminate (or mitigate) delamination of the multilayer structure forming cell 10, thereby improving performance of cell 10 (e.g. increased life, increased capacity, increased number of charge/discharge cycles, etc.).

In some embodiments the common non-polar polymer is SIBS. SIBS is a triblock thermoplastic copolymer that has been used in some biomedical applications. SIBS may have a high stretchability (e.g. about 680% to 700%), be chemically stable, be biocompatible, have an extremely low moisture permeability (e.g. less than about 80×10⁻¹⁰ cm³·cm/(cm²·s·cmHg) at 40° C.), etc. as a result of a controlled distribution of isoprene and butadiene monomer units in its mid-block.

Anode 13 and cathode 15 may comprise any metals and/or metallic or inorganic oxides such as lithium, sodium, potassium, silicon, germanium, aluminum, magnesium, zinc, gallium, arsenic, silver, indium, tin, lead, bismuth, alloys or derivatives thereof and/or the like. In some embodiments anode 13 comprises zinc (“Zn”) and cathode 15 comprises MnO₂. The combination of Zn/MnO₂ may advantageously result in electrodes 12 which have a low toxicity, low cost, reduced processing complexity and/or the like.

Separator 17 may comprise a sponge-like morphology with pores. As described elsewhere herein, separator 17 carries an electrolyte solution and facilitates movement of ions between anode 13 and cathode 15 and vice versa. The rate of ion transfer may be varied by varying the size of the pores within separator 17. Increasing the size of the pores may increase the rate of ion transfer. Decreasing the size of the pores may reduce the rate of ion transfer. Additionally, or alternatively, the rate of ion transfer may be varied by varying a composition of the electrolyte solution (e.g. varying a size of one or more ions in the electrolyte solution).

In some embodiments, the pores of separator 17 are small (e.g. about 1-5 μm), thereby allowing slow ion transfer between anode 13 and cathode 15. Such pore structure may advantageously reduce the likelihood of self-discharge, avoid internal short circuits if cell 10 undergoes mechanical excitation, etc.

Separator 17 may be loaded with an electrolyte solution (e.g. an electrolyte solution may be injected using a syringe or otherwise introduced into separator 17). In some embodiments the electrolyte solution is loaded into separator 17 through encapsulation 18. The electrolyte solution may be loaded into separator 17 before, during or after assembly of cell 10 described elsewhere herein.

An electrolyte pair can be chosen based on the pair of active materials in electrodes 12. For example, ZnSO₄ and MnSO₄ may be chosen as electrolytes for the active electrode pair of Zn/MnO₂. In some embodiments the electrolyte comprises a solution comprising 2M ZnSO₄+0.2M MnSO₄. Cycling stability may, for example, be significantly increased by adding MnSO₄ additive into ZnSO₄ aqueous solvent to suppress the dissolution of Mn²⁺ in the positive electrode (e.g. electrode 12+). This suppressed dissolution of Mn²⁺ may advantageously result in improved rechargeability of cell 10, reduced cost of cell 10, etc.

In some cases the addition of MnSO₄ increases the cycle life by about 12.5 times relative to a cell which does not comprise MnSO₄ in the electrolyte solution (e.g. from about 400 charge/discharge cycles to about 5000 charge/discharge cycles). In some cases the addition of MnSO₄ maintains a capacity of cell 10 of at least 90% of the original capacity of cell 10 after 5000 charge/discharge cycles. In some cases the addition of MnSO₄ maintains a capacity of cell 10 of at least 92% of the original capacity of cell 10 after 5000 charge/discharge cycles.

Cell 10 may have a highly reversible specific capacity of about 160 mAH/g even after 1150 stretching cycles at 100% strain without any visible delamination. Cell 10 may have a 75% retention capacity after 500 cycles of charge and discharge.

Cell 10 may be a rechargeable electrochemical cell. However, this is not mandatory. In some embodiments, cell 10 cannot be re-charged.

Cell 10 may have one or more of the following properties (non-limiting):
is operable in a wide range of temperatures (e.g. about −20° C. to 50° C.);
is washable in a commercial or residential washing machine for more than 23 times without any noticeable leaking or capacity loss;
has a long shelf-life (e.g. more than about 6 months) with minimum amounts (e.g. about 0-7%) of electrolyte solution evaporation;
etc.

Cell 10 may, for example, have an operating voltage between 0.8 V and 1.8 V. In some embodiments cell 10 has a voltage rating of 1.5 V.

Cell 10 may, for example, have a maximum current rating of 10 mAh/cm². In some embodiments cell 10 has a current rating between 3 mAh/cm² and 5 mAh/cm².

Cell 10 and/or individual components of cell 10 may have varying dimensions based on an intended application for cell 10 and/or desired performance characteristics. For example, increasing an overall size of cell 10 (or an overall size of individual components such as separator 17) may increase capacity, shelf-life, etc. of cell 10. In one example case (non-limiting), cell 10 comprises:
a multi-layer (e.g. top and bottom layer) encapsulation 18 as described elsewhere herein where each layer of the encapsulation is about 25±10% mm long, 15±10 mm wide and 0.1±10% mm thick;
current collectors 14 and 16 which are each about 30±10% mm long, 10±0% mm wide and 0.1±10% mm thick;
cathode 15 which is about 20±10% mm long, 10±10% mm wide and 0.07±10% mm thick;
anode 13 which is about 20±10% mm long, 10±10% mm wide and 0.0±10%3 mm thick; and
separator 17 which is about 25±10% mm long, 15±10% mm wide and 0.12±10% mm thick.

In some embodiments one or both of current collectors 14 and 16 extend beyond encapsulation 18. For example, current collectors 14, 16 may extend longitudinally outwards from a peripheral surface of encapsulation 18 (see e.g. FIG. 1A). This extension of current collectors 14, 16 beyond encapsulation 18 advantageously may provide electrical contacts for coupling cell 10 to a desired load, additional cell 10, etc. In some embodiments at least one of current collectors 14, 16 extends beyond encapsulation 18 by about 5±10% mm.

Cell 10 may have a thickness that is less than 1 mm. In some embodiments cell 10 has a thickness that is less than 0.5 mm.

In some embodiments a plurality of cells 10 are coupled together (e.g. electrically and/or physically) to form a larger electrochemical cell.

Individual components of cell 10 and different aspects of the invention will now be described in more detail.

### Current Collectors

Current collectors 14, 16 provide a path for electrons to flow from anode 13 to cathode 15 through, for example, an electrically coupled external load L (see e.g. FIG. 1C). Preferably, current collectors 14, 16 comprise highly conductive and highly stretchable conductors.

The inventors have discovered that by combining a highly stretchable non-polar polymer with one or more carbon-based materials it is possible to make an electrical conductor that is both highly conductive (e.g. greater than about 230 S/m) and highly stretchable (e.g. greater than about 100% strain). Such conductor may also maintain its performance within a threshold performance range despite being repeatedly stretched and relaxed (i.e. repeatedly “mechanically cycled” as may be known in the art). For example, the conductor may comprise a resistance value that increases by less than a factor of 2 when the conductor is stretched and relaxed more than about 100 times at a strain of at least 100%. Such a conductor may also be easily and inexpensively manufactured (e.g. by doctor blading, stencil printing, etc.).

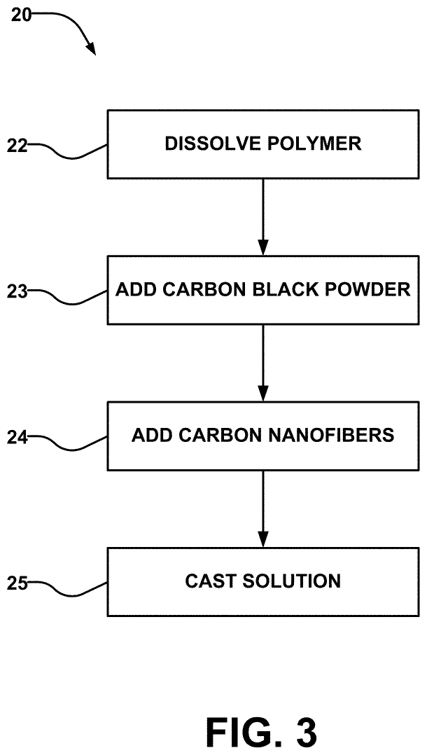

The conductor used for current collectors 14, 16 may comprise SIBS polymer (or any other non-polar polymer described herein) and one or more carbon-based materials. The carbon-based materials may comprise carbon allotropes such as graphite, graphene, carbon powders, acetylene black, carbon nanotubes, carbon nanofibers and/or the like. The addition of the carbon allotropes (or other carbon-based materials) increases the conductivity of the SIBS polymer. The addition of carbon allotropes (or other carbon-based materials) having a high tensile strength (e.g. carbon nanofibers which have a tensile strength of about 5 GPa) may increase tensile strength of the polymer (relative to polymer without the carbon-based additive) and therefore the tensile strength of the conductor. The increased tensile strength reinforces the polymer structure of the conductor, thereby increasing its Young's modulus (i.e. a greater force is required to deform the conductor and the electrical pathways formed by the nanofibers within the conductor). FIG. 2 graphically illustrates example Young's moduli of SIBS substrate (leftmost plot), an example conductor comprising carbon black powder (denoted as “SC” and forming the central plot in FIG. 2) and an example conductor comprising carbon black powder and carbon nanofibers (denoted as “SCC10” and forming the rightmost plot in FIG. 2).

In some embodiments the conductor comprises carbon black powder. In some embodiments the conductor comprises carbon black powder and carbon nanofibers.

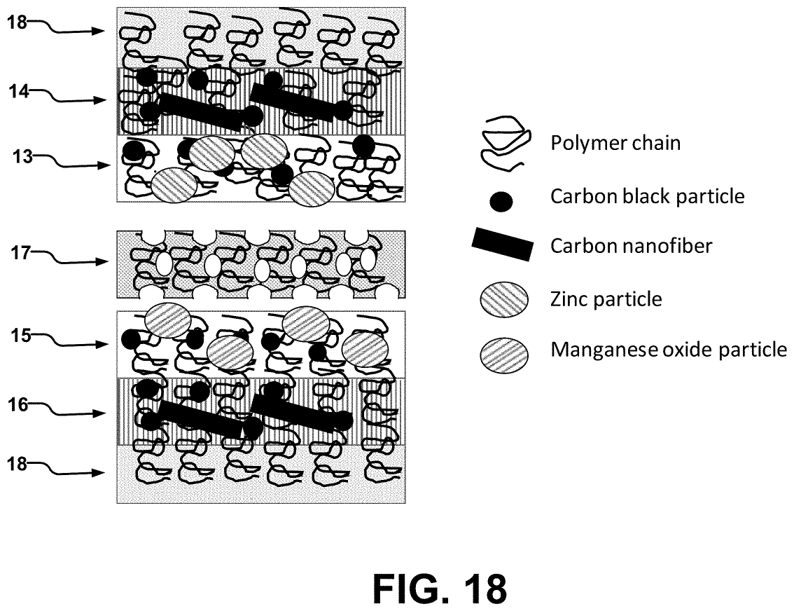

Depending on what carbon-based materials are incorporated into the conductor, different conductors may have different morphologies. For example, a conductor comprising SIBS and carbon black powder may have a homogeneous distribution of carbon black powder particles on surfaces of the conductor. A conductor comprising SIBS, carbon black powder and carbon nanofibers may comprise carbon black powder particles coupled to the carbon nanofibers (see e.g. schematic illustration in FIG. 18). By having carbon black powder particles coupled to the carbon nanofibers, the carbon nanofibers may maintain electrical pathways within the polymer despite repeated mechanical strain. This advantageously may maintain high electrical conductivity of the conductor.

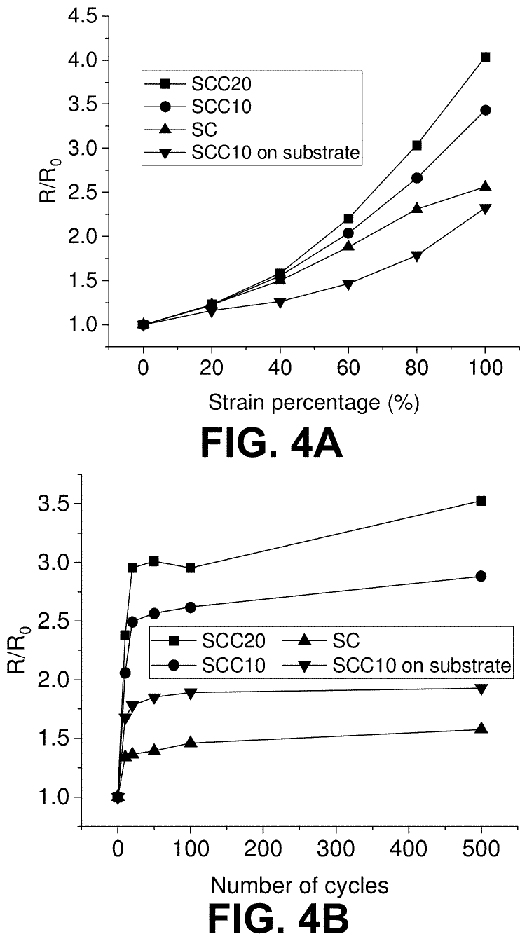

FIG. 3 is a block diagram showing an example method 20 for fabricating a stretchable conductor as described herein.

In block 22, a non-polar polymer (e.g. SIBS) is dissolved in a solvent (e.g. toluene). The non-polar polymer may, for example, comprise SIBS (e.g. SIBS grains, SIBS pellets, etc.).

In block 23, carbon black powder is added to the solution. An amount of the carbon black powder to be added to the solution may be determined according to a weight ratio of x_{CB} parts carbon black powder to y_{polymer} parts non-polar polymer, wherein x_{CB} represents how many parts carbon black powder are added to the solution and y_{polymer} represents how many parts of the non-polar polymer are in the solution. For example, carbon black powder may be added to the solution according to a weight ratio of x_{CB} parts carbon black powder to 10 parts SIBS, wherein x_{CB} may be 3, 4, 5, 6, etc.

The inventors have found that increasing the amount of carbon black powder increases conductivity of the conductor. However, increasing the amount of carbon black powder may also increase the likelihood of cracks (or other voids) developing in the film upon drying. A ratio of 4 parts carbon black powder to 10 parts SIBS has been found to provide high conductivity (e.g. about 100 S/m) without any cracking.

In block 24, the conductivity of the conductor is further increased by adding carbon nanofibers to the solution. An amount of the carbon nanofibers to be added to the solution may also be determined according to a weight ratio of x_{CNF} parts carbon nanofibers to y_{polymer} parts non-polar polymer, wherein x_{CNF} represents how many parts carbon nanofibers are added to the solution. For example, carbon nanofibers may be added to the solution according to a weight ratio of x_{CNF} parts carbon black powder to 10 parts SIBS, wherein x_{CNF} may be 1, 2, 3, etc.

The inventors have found that the addition of carbon nanofibers may significantly increase the conductivity of the conductor. However, like for the addition of the carbon black powder as discussed above, increasing the amount of carbon nanofibers may also increase the likelihood of cracks (or other voids) developing in the film upon drying. A ratio of 2 parts carbon nanofibers to 10 parts SIBS has been found to provide significantly higher conductivity (e.g. about 467 S/m) without any cracking.

In some embodiments an amount of carbon nanofibers to be added to the solution is optimized for a desired application of the conductor (e.g. using a cost function which assigns a weight to each of conductivity and stretchability of the conductor). For example, in applications where conductivity of the conductor is more important than stretchability of the conductor, a conductivity term of the cost function may be more heavily weighted (as compared to applications where stretchability is more important) and a higher amount of carbon nanofibers may be added to the solution. In applications where stretchability of the conductor is more important than conductivity of the conductor, a stretchability term of the cost function may be more heavily weighted (as compared to applications where conductivity is more important) and a lower amount of carbon nanofibers may be added to the solution.

In block 25, the solution is cast to form the conductor. For example, the solution may be doctor bladed on a substrate. The substrate may, for example, comprise a SIBS substrate. As another example, the solution may be stencil printed.

In some embodiments, conductivity of the conductor is increased by adding a thin copper layer (e.g. in a range of 0.1-10 μm) thickness over a surface of the conductor. In some embodiments the copper layer is electroplated or electroless plated onto the conductor. However, such a copper layer may generally be layered on the conductor using any suitable technique.

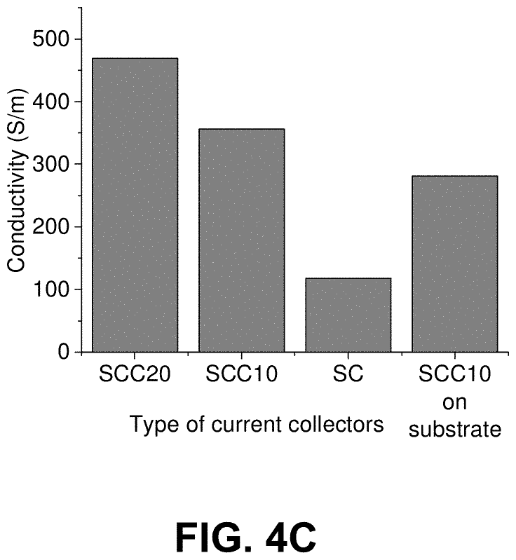

FIGS. 4A to 4C graphically illustrate properties of the following four different example types of conductors:
SC (comprises 4 parts carbon black powder to 10 parts SIBS);
SCC10 (comprises 4 parts carbon black powder to 10 parts SIBS and 1 part carbon nanofibers to 10 parts SIBS);
SCC20 (comprises 4 parts carbon black powder to 10 parts SIBS and 2 parts carbon nanofibers to 10 parts SIBS);
SCC10 on SIBS substrate.

FIG. 4A illustrates normalized resistances (R/R₀) of the four different example types of conductors under various strain conditions from 0 to 100%. FIG. 4B illustrates normalized resistances (R/R₀) of the four different example types of conductors in resting state after being stretched at 100% strain for a number of cycles. FIG. 4C illustrates conductivity (in S/m) of the four different example types of conductors.

Current collectors 14, 16 may each comprise a conductor as described herein. In currently preferred embodiments current collectors 14, 16 comprise conductors comprising 4 parts carbon black powder to 10 parts SIBS and 1 part carbon nanofibers to 10 parts SIBS. Such conductors may advantageously have sheet resistances which do not significantly increase after repeated mechanical strain (e.g. enlarges only about 1.8 times from 14.8Ω/□ (Ohms/square) to 26.6Ω/□ (Ohms/square) after 500 cycles at 100% strain).

### Negative Electrode

One or more oxidation reactions (e.g. loss of electrons) may occur at electrode 12−. Electrode 12− of cell 10 may be fabricated using a multi-step process. As a first step, current collector 14 may be fabricated. Anode 13 may then be fabricated over at least a portion of a surface (or surfaces) of current collector 14. In some embodiments an anode paste is deposited over at least a portion of a surface of current collector 14. Additionally, or alternatively, anode 13 may be fabricated by adding metal particles to at least a portion of a surface of current collector 14 by a process such as electroplating, electrospinning, etc.

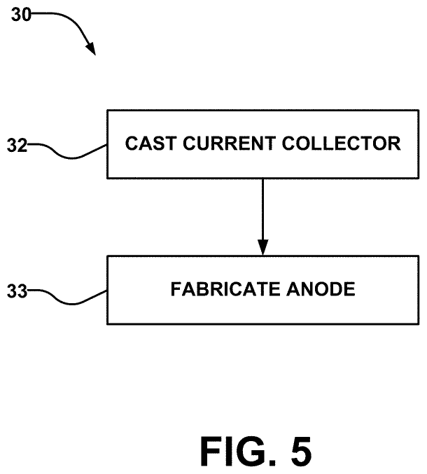

FIG. 5 is a flow chart illustrating an example method 30 for fabricating an example electrode 12− of cell 10.

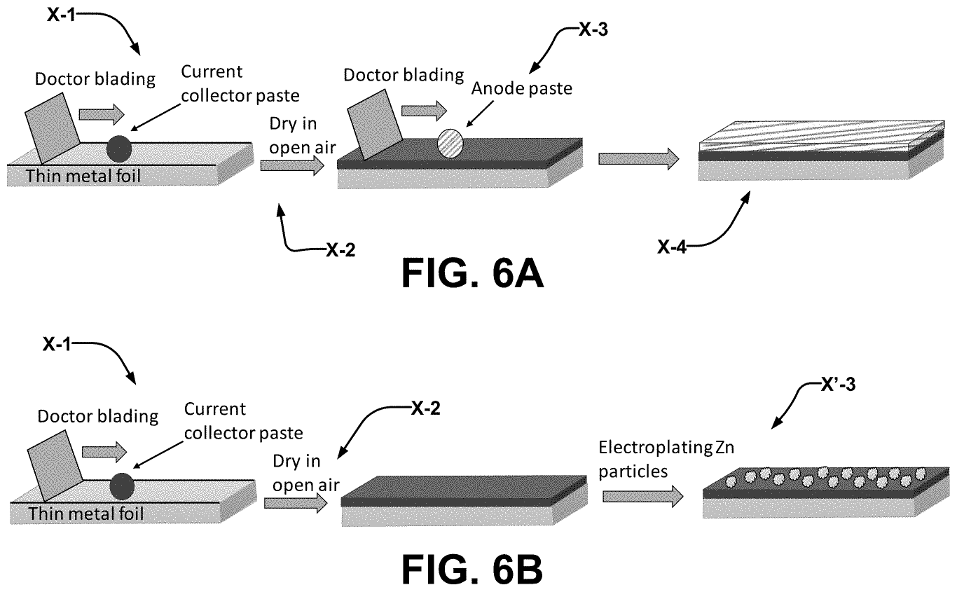

In block 32, current collector 14 is cast. Current collector 14 may be cast by depositing a solution (e.g. a “current collector paste”) on a highly conductive substrate (see e.g. step X-1 in FIGS. 6A and 6B). The substrate may comprise an indium tin oxide (ITO) coated glass slide, a fluorine doped tin oxide (FTO) glass slide and/or the like. In some embodiments the substrate is flat. In some embodiments the substrate comprises a metallic substrate (e.g. aluminum, titanium, copper, etc.). In some embodiments the substrate is an electrically insulative substrate comprising surfaces coated with an electrically conductive material. The solution may be cast, for example, using doctor blading. This may create a thin film (e.g. about 100 μm) of the current collector paste.

As described elsewhere herein the current collector paste may comprise SIBS (e.g. about 20% by weight) dissolved in toluene, carbon black (e.g. about 40% by weight of SIBS) and carbon nanofibers (e.g. about 10% by weight of SIBS).

Once cast, the thin film of the current collector paste may be dried (see e.g. step X-2 in FIGS. 6A and 6B). The thin film may, for example, be dried in open air (e.g. for about 3 hours).

In some embodiments, as described elsewhere herein, a thin copper layer is added over at least a portion of a surface of current collector 14 to improve conductivity of current collector 14 prior to fabricating anode 13. In some embodiments the thin copper layer is added to portions of surface of current collector 14 which will be covered by anode 13.

Upon current collector 14 drying (at least partially), anode 13 is fabricated in block 33.

In some embodiments an anode paste is cast over at least a portion of a surface of current collector 14. For example, the anode paste may be doctor bladed on current collector 14 (see e.g. step X-3 in FIG. 6A). The anode paste may comprise a solution comprising a metal (e.g. zinc), a carbon-based material (e.g. carbon black powder) and a non-polar polymer (e.g. SIBS) dissolved in a solvent. A solvent for the solution may, for example, comprise or be toluene. In some embodiments the anode paste comprises a solution of zinc (e.g. about 90% by weight of SIBS), carbon black powder (e.g. about 5% by weight of SIBS) and SIBS (e.g. about 5% by weight) dissolved in toluene. In some embodiments the anode paste is doctor bladed at a speed of about 120 mm/min. The cast anode paste may be about 300±10% μm thick. Once cast, the anode paste is dried (see e.g. step X-4 in FIG. 6A).

In some embodiments an anode paste is electrospun on at least a portion of a surface of current collector 14 to create anode 13. The electrospun layer may have a thickness of about 200±10% μm. In such embodiments, the anode paste may, for example, comprise Zn powder (e.g. about 800% by weight of SIBS) and carbon black powder (e.g. about 50% by weight of SIBS) dissolved in a solution of SIBS (e.g. about 20% by weight) and toluene. Preferably, the anode paste is mixed prior to application until a homogenous solution is formed (e.g. about six minutes using a Thinky™ mixer).

In some embodiments metal particles (e.g. Zn) may be electroplated on at least a portion of a surface of the fabricated current collector 14 to form anode 13 (see e.g. step X′-3 in FIG. 6B). In some embodiments partly constructed electrode 12− (e.g. the electrode to be electroplated with the Zn particles) is connected to a negative electrode of a potentiostat and a thin Zn film is connected to the positive electrode of the potentiostat. The two electrode system may be immersed into a ZnSO₄ solution (e.g. having a concentration of about 2M) and a current (e.g. density of about 20 mA/cm²) may be applied for a set amount of time (e.g. 300 seconds). Electrode 12− may then be washed (e.g. with de-ionized water) and dried (e.g. in open air) for a set amount of time (e.g. about 2 hours).

### Positive Electrode

One or more reduction reactions (e.g. gain of electrodes) may occur at electrode 12+. Electrode 12+ of cell 10 may be fabricated using a multi-step process. As a first step, current collector 16 may be fabricated. Cathode 15 may then be fabricated over at least a portion of a surface (or surfaces) of current collector 16. In some embodiments cathode 15 is fabricated by depositing a cathode paste over at least a portion of current collector 16. In some embodiments cathode 15 may be fabricated by electroplating.

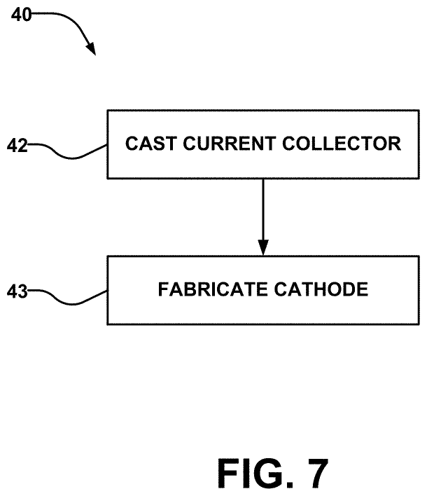

FIG. 7 is a flow chart illustrating an example method 40 for fabricating an example electrode 12+ of cell 10.

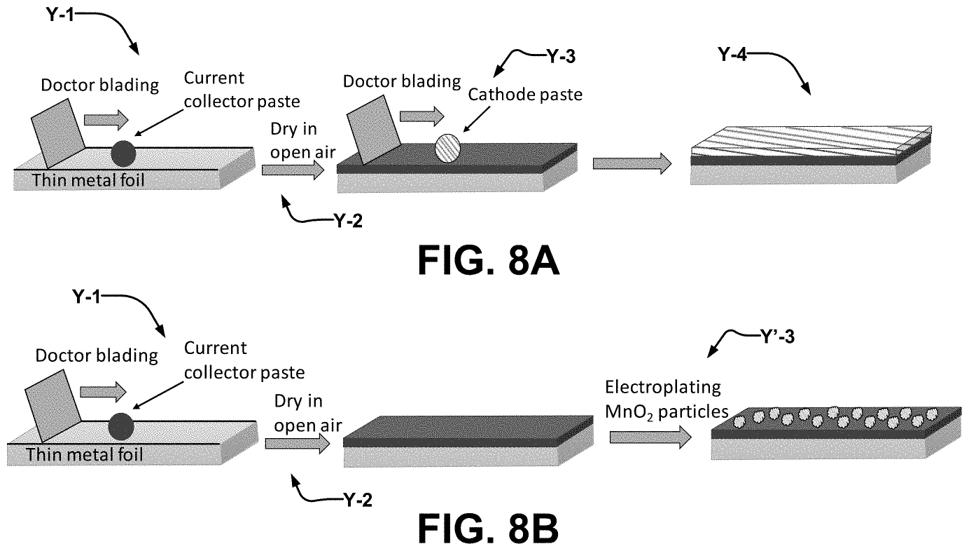

In block 42 current collector 16 is cast. Current collector 16 may be cast by depositing a solution (e.g. a “current collector paste”) on a glass slide (see e.g. step Y-1 in FIGS. 8A and 8B). The solution may be cast, for example, using doctor blading. This may create a thin film (e.g. about 100 μm) of the current collector paste. Once the current collector paste is deposited, the thin film is dried (e.g. for about 2 hours at ambient temperature) (see e.g. step Y-2 in FIGS. 8A and 8B).

As described elsewhere herein the current collector paste may comprise SIBS (e.g. about 20% by weight) dissolved in toluene, carbon black (e.g. about 40% by weight of SIBS) and carbon nanofibers (e.g. about 10% by weight of SIBS).

In some embodiments, as described elsewhere herein, a thin copper layer is added over at least a portion of a surface of current collector 16 to improve conductivity of current collector 16 prior to fabricating cathode 15. In some embodiments the thin copper layer is added to portions of surface of current collector 16 which will be covered by cathode 15.

Once current collector 16 is dry (at least partially), cathode 15 is fabricated in block 43.

In some embodiments a cathode paste is deposited over at least a portion of a surface of current collector 16. The cathode paste may, for example, be deposited on the surface(s) of current collector 16 by doctor blading (see e.g. step Y-3 in FIG. 8A).

The cathode paste may comprise a solution comprising a metal oxide, a polyanionic compound or cyanoferrate, a carbon-based material and a non-polar polymer. In some embodiments the solution comprises MnO₂ powder (e.g. about 800% by weight of SIBS) and carbon black powder (e.g. about 50% by weight of SIBS) dissolved in a solution of SIBS (e.g. about 20% by weight) and toluene.

Once cast, the cathode paste is dried (see e.g. step Y-4 in FIG. 8A). The cathode paste may for example be dried on a hot plate for a set amount of time (e.g. about 2 hours) at a set temperature (e.g. about 60° C.).

In some embodiments cathode 15 is fabricated by a method of electroplating. For example, metal oxide or inorganic compound particles (e.g. MnO₂) may be electroplated on at least a portion of a surface of the fabricated current collector 16 to form cathode 15 (see e.g. step Y′-3 in FIG. 8B).

### Separator

Separator 17 comprises pores and may carry an electrolyte solution. The pores within separator 17 facilitate and/or restrict ion movement between anode 13 and cathode 15 or vice versa. In some embodiments a separator having a porous structure may be fabricated using a phase separation method. In preferred embodiments separator 17 is fabricated using a method of solvent evaporation-induced phase separation (“SIPS”).

In phase separation, a homogeneous single-phase polymer solution may initially be formed where all components are miscible. Upon introduction of another solvent, this single-phase may then be broken up into two phases, due to changes in equilibrium compositions: (i) a polymer-rich phase; and (ii) a polymer-poor phase. The polymer-poor phase may produce voids in the membrane while the polymer-rich phase may retain the voids and may form the final membrane.

Based on different physical manners of changing the equilibrium compositions of the solution, the phase separation method may be classified into four classes: (i) nonsolvent induced phase separation; (ii) thermally induced phase separation; (iii) vapor induced phase separation; and (iv) solvent evaporation-induced phase separation (“SIPS”).

In the SIPS method, a polymer is preferably dissolved in a mixture comprising a solvent (i.e. a substance which can dissolve the polymer) having a high evaporation rate and a nonsolvent (i.e. a substance which cannot dissolve the polymer) having a low evaporation rate relative to the solvent. Upon the solvent being evaporated from the solution, phase separation may occur due to the growth and coalescence of nonsolvent-rich droplets. The porous membrane may be formed when the nonsolvent droplets are removed.

The SIPS method may advantageously provide a higher reproducibility compared to other phase separation methods. Additionally, or alternatively, the SIPS method may be simpler, less expensive, less time intensive, etc. compared to other phase separation methods as a result of being coagulation bath free.

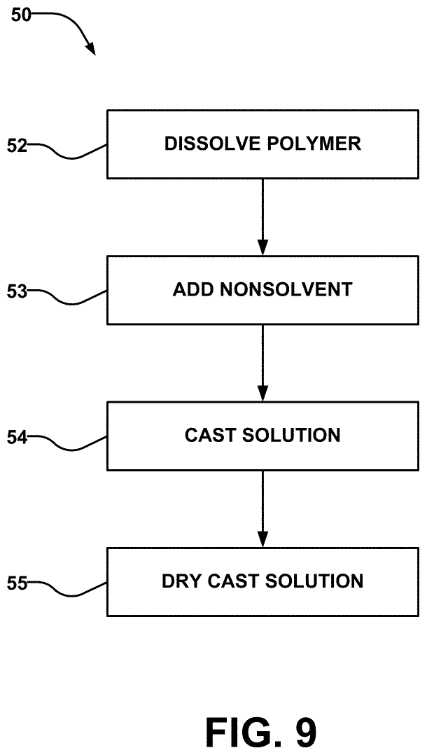

FIG. 9 illustrates an example SIPS method 50 for fabricating an example separator 17.

In block 52, a non-polar polymer is dissolved. For example, the SIBS triblock copolymer may be dissolved in toluene. In some embodiments the solution comprises 1 part SIBS to 10 parts toluene. In some embodiments the solvent comprises one or more of the group consisting of toluene, chloroform, dichloromethane and trichloroethylene.

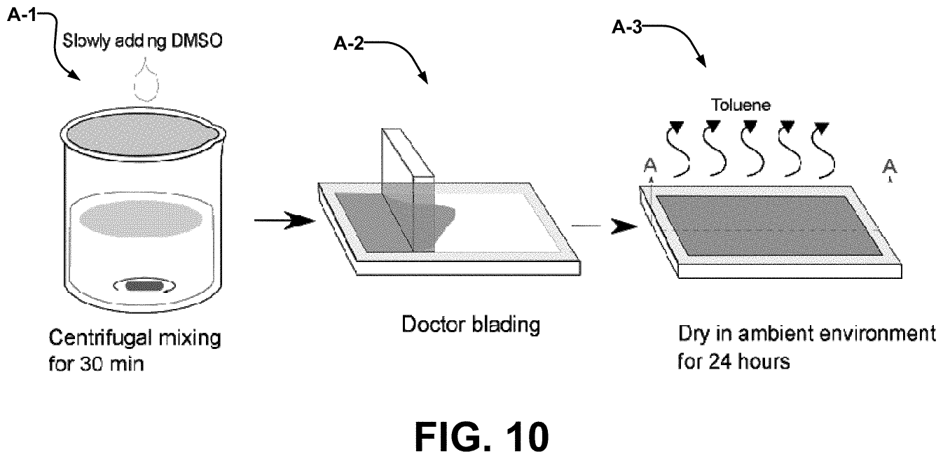

In block 53, a nonsolvent (e.g. that cannot dissolve SIBS) is added to the solution. For example, dimethyl sulfoxide (DMSO) may be added as the nonsolvent (see e.g. step A-1 in FIG. 10). In some embodiments the nonsolvent comprises one or more of the group consisting of hexane, acetone, butanol, 2-propanol, tetrahydrofuran (THF), DMSO, methanol and water.

The nonsolvent may be slowly (e.g. about 1 drop per second) added to the solvent (e.g. toluene) while it is being stirred (e.g. using centrifugal mixing, using a magnetic stirring machine, etc.). The solution may be stirred for a set amount of time (e.g. about 30 minutes, 2 hours, etc.).

In block 54 the solution resulting from block 53 is cast on a substrate (see e.g. step A-2 in FIG. 10). For example, the solution may be doctor bladed on the substrate. In some embodiments the substrate comprises glass. As another example, the solution may be drop cast.

The cast solution is dried in block 55 (see e.g. step A-3 in FIG. 10). During the evaporation process, the cast solution may change color. For example, an originally clear solution may slowly transition to a cloudy solution as a result of phase separation between DMSO and SIBS that induces scattering of visible light. After solvent (e.g. toluene) evaporation is complete, the resulting film may optionally be slowly dried (e.g. in a fume hood for about 24 hours).

The pore growth mechanism may be divided into three main steps after the solution has been cast and is drying as follows:
(i) evaporation of toluene (the solvent phase) and formation of DMSO-rich droplets (non-solvent phase);
(ii) complete evaporation of toluene and growth of DMSO-rich droplets through entire thickness of the cast separator; and
(iii) removal of the DMSO phase.

After the solution has been cast on the substrate, the solvent starts to evaporate and phase separation may occur at one or more cast solution/air interfaces. As this occurs, the percentage weight of toluene in the cast solution decreases while the percentage weight of SIBS and DMSO increases. This may induce a flow of low molecular weight fluid (e.g. molecular weight DMSO=78.13 g/mol is less than molecular weight of toluene=92.14 g/mol) into the zones of the cast solution with low polymer concentration, resulting in the formation of DMSO-rich droplets.

The evaporation of solvent may rapidly cool off the surface of the cast solution. This may cause a temperature gradient between the top and bottom of the cast solution. The resulting convection flow downward and solvent diffusion upward to evaporate may help to accelerate the formation of DMSO-rich droplets. The phase separation therefore may start from the cast solution/air interface(s) and move away from the cast solution/air interface(s) (e.g. downwards toward a bottom surface of the cast solution).

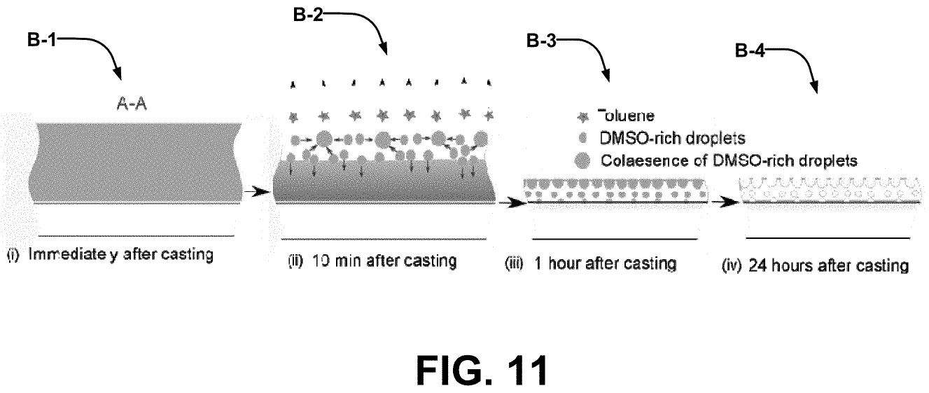

Stages B-1 to B-4 in FIG. 11 schematically illustrate an example evolution of the casting solution and the formation of the pores within separator 17 as the cast solution dries. Stage B-1 shows the example solution immediately after casting. Stage B-2 shows the solution 10 minutes after casting. Stage B-3 shows the solution 1 hour after casting. Stage B-4 shows the solution 24 hours after casting.

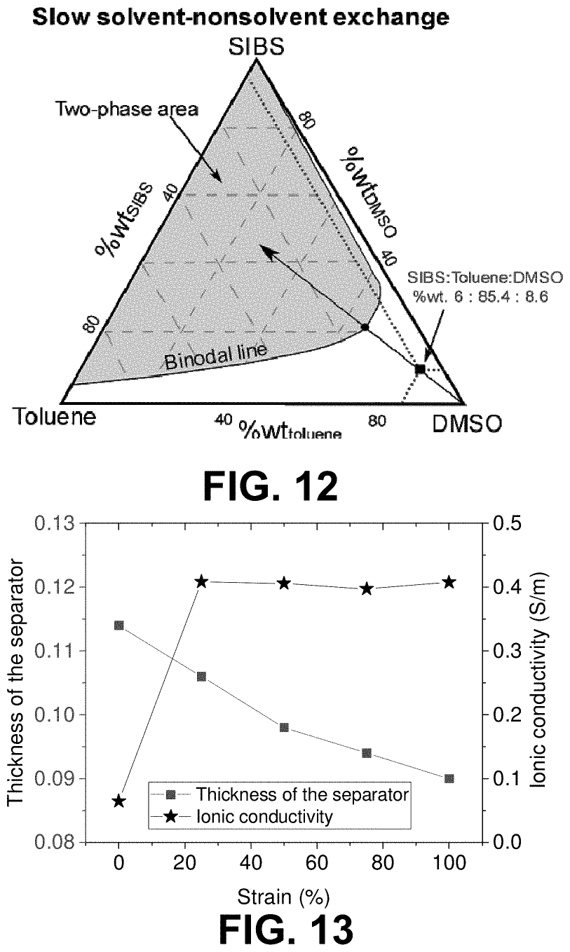

FIG. 12 is a ternary phase diagram illustrating the evolution of compositions within the example cast solution as the solvent (e.g. toluene) evaporates. FIG. 12 shows three different components of the solution (e.g. DMSO, toluene, SIBS) at the three vertices of the triangle and a binodal line dividing the triangle into one phase and two-phase areas. An example composition of SIBS:toluene:DMSO of percent weight of 6 parts to 85.4 parts to 8.6 parts respectively was used for the casting solution that produced the FIG. 12 results. The composition path (black arrow extending from lower right upwardly and leftwardly) after the solution was cast indicates transition from one phase to two-phases during toluene evaporation.

The pore structure of the pores within separator 17 (e.g. porosity, pore size, pore distribution, etc.) may be dependent on several factors. Such factors may include one or more of the following (non-limiting):
miscibility differences between the solvent (e.g. toluene) and nonsolvent (e.g. DMSO);
volatility differences (e.g. differences in evaporation rates) between solvent (e.g. toluene) and non-solvent (e.g. DMSO);
concentration of polymer solution (e.g. concentration of SIBS solution);
percentage weight of non-solvent (e.g. DMSO) relative to solvent (e.g. toluene);
thickness of casting solution;
ambient temperature;
amount of ventilation or other air-flow within environment in which the cast solution will be dried;
addition of additives such as surfactants;
etc.

The miscibility between two substances may be correlated to their polarities. Substances having similar polarities tend to be miscible. For example, toluene is a non-polar substance which can be mixed with DMSO as it is a highly aprotic polar substance that dissolves both polar and nonpolar compounds. In some cases miscibility of common substances may readily be looked-up using commonly available sources (e.g. on the internet, in tables included in text books, etc.). If the miscibility of a substance cannot easily be found (e.g. the substance is not commonly used) the miscibility of the substance can be predicted by employing the same rules as for solubility. For example, miscibility can be predicted by computing the Hansen solubility parameter distance Rₐ. Rₐ may, for example, be computed as follows:

Rₐ=\sqrt{4(δ_{ds}−δ_{dNS})²+(δ_{pS}−δ_{pNS})²+(δ_{hS}−δ_{hNS})²} (1)

wherein δ_{d}, δₚ and δₕ are the energy from dispersion forces between molecules, polar forces between molecules and hydrogen bonds between molecules of a liquid, respectively. S represents a solvent and NS represents a nonsolvent.

As described elsewhere herein, the solvent may comprise one or more of the group consisting of toluene, chloroform, dichloromethane and trichlorethylene. In some embodiments toluene is preferably selected as the solvent due to its lowest evaporation rate among these solvents. The Rₐ values of various different nonsolvents, including hexane, acetone, butanol, 2-propanol, tetrahydrofuran (THF), DMSO, methanol and water, in combination with toluene are respectively 6.6, 11.4, 13.9, 15.8, 7.8, 17.1, 24, and 43.2 MPa^{1/2} (δ_{d}, δₚ and δₕ of these solvents can be computed from the Hansen solubility parameters). As can be seen from these values, hexane has the highest mutual affinity with toluene of the group of nonsolvents described above while water and toluene are nearly immiscible. Having a relatively low affinity may advantageously facilitate the fabrication of a sponge-like membrane structure in separator 17. For example, DMSO and toluene have a relatively high Ra, thereby indicating that these two substances have a relatively low affinity in comparison to a THF and DMSO substance pair. Having a relatively low affinity may advantageously lead to a slow formation of DMSO-rich droplets and thereby facilitate the fabrication of a sponge-like membrane structure in separator 17.

Another factor which may contribute to the formation of porosity in separator 17 is the difference in volatility of the solvent and nonsolvent (i.e. the difference in evaporation rates). The relative evaporation rates (here “relative” means a ratio of the evaporation rate of a particular substance to the evaporation rate of n-butyl acetate, wherein the evaporation rate for n-butyl acetate is assumed to be 1) of hexane, acetone, butanol, 2-propanol, THF, DMSO, methanol, water and toluene are respectively 8.3, 6.3, 0.93, 1.7, 6.3, 0.026, 2.1, 0.3, and 1.9. As can been seen from this, DMSO has a much lower evaporation rate in comparison to toluene. This advantageously contributes to slow nucleation, growth and coalescence of DMSO.

In some embodiments the different factors are used to make the selection of a solvent and nonsolvent pair based on a desired porosity for separator 17. For example, selecting a nonsolvent that has an evaporation rate that is similar to the evaporation rate of the solvent may produce a separator 17 having very few pores (may result in a separator 17 having a very dense structure that is almost impermeable to ions (i.e. almost “non-conductive”)). As another example, selecting a nonsolvent that has an evaporation rate that is very different to the evaporation rate of the solvent may produce a separator 17 having a relatively large number of pores and/or relatively large pores. In some cases having large pores may be disadvantageous, since this may increase the likelihood of electrodes 12− and 12+ coming into physical contact with one another. As described elsewhere herein DMSO may be a good nonsolvent to pair with toluene.

Concentration of the polymer may also be a factor affecting the phase separation process. A low polymer concentration reduces the viscosity of the solution. This facilitates currents within the liquids, convection flows, etc. which may assist with the growth and coalescence of DMSO-rich droplets.

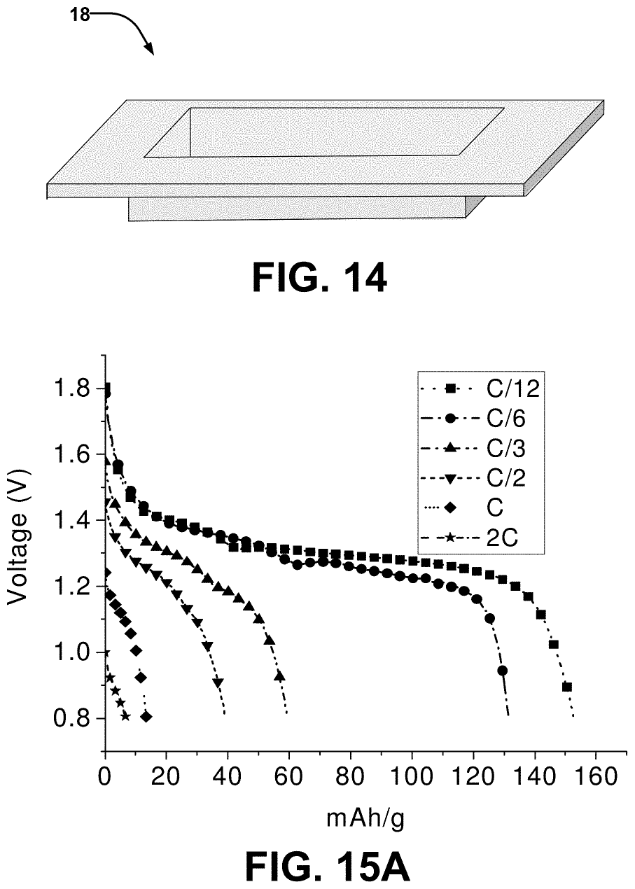

FIG. 13 graphically illustrates conductivity of an example SIBS separator fabricated according to method 50 described elsewhere herein. As shown in FIG. 13, the separator initially has an ionic conductivity of 0.05 S/m. The ionic conductivity increases to 0.4 S/m when the membrane is being stretched at 100%.

In some embodiments some factors of the phase separation process are prioritized over other factors to fabricate a separator 17 having desired performance characteristics. In some such embodiments the selection of phase-separation factors used in fabricating separator 17 is optimized using a cost function having a cost term associated with each phase-separation factor to be considered. Particular phase-separation factors can then be assigned relative importance in the optimization process by assigning relative weights to the terms of the cost function.

### Encapsulation

Encapsulation 18 may prevent loss of electrolyte solution (e.g. by leaking), prevent particles, liquids, etc. outside of cell 10 from entering cell 10, protect components of cell 10 from damage and/or the like.

In some embodiments encapsulation 18 comprises one or more non-polar polymer films or layers (e.g. SIBS films) that may be fused into a single encapsulation structure which encloses components of cell 10. For example, encapsulation 18 may comprise a bottom film and a top film which are bonded together to fully enclose components of cell 10. In some embodiments, encapsulation 18 may partially enclose the components of cell 10.

Different layers of encapsulation 18 may be the same or different. Different layers of encapsulation 18 may enclose the same or different amounts of surface area of the components of cell 10. Different layers of encapsulation 18 may have the same or different thicknesses. In some embodiments one layer (e.g. a top layer) encloses more of cell 10 than another layer (e.g. a bottom layer).

Different layers of encapsulation 18 may comprise the same or different material compositions. In currently preferred embodiments, adjacent layers of encapsulation 18 comprise at least one common non-polar polymer. In some embodiments all layers of encapsulation 18 comprise a common non-polar polymer.

One example method to fabricate a film (e.g. a SIBS film) for encapsulation 18 comprises casting a solution of SIBS and toluene on a flat and rigid substrate such as a glass slide. Any known casting method may be used such as doctor blading, spin casting, drop casting, etc. Once cast, the thin film may be dried (e.g. by placing the cast solution in a fume hood at room temperature until the weight of the resulting film approaches a constant value).

Additionally, or alternatively, a film may be fabricated using a method of hot pressing. For example, SIBS grains, pellets, etc. may be pressed between two metal plates at a set temperature (e.g. about 205° C.) and set pressure (e.g. about 70 kPa) for a set amount of time (e.g. about three minutes). In some embodiments, such temperature, pressure and/or time need not be set and can vary. This hot pressing technique may result in a SIBS thin film having a thickness of, for example, about 200 μm. The thickness of the film may be varied by changing an amount of applied pressure.

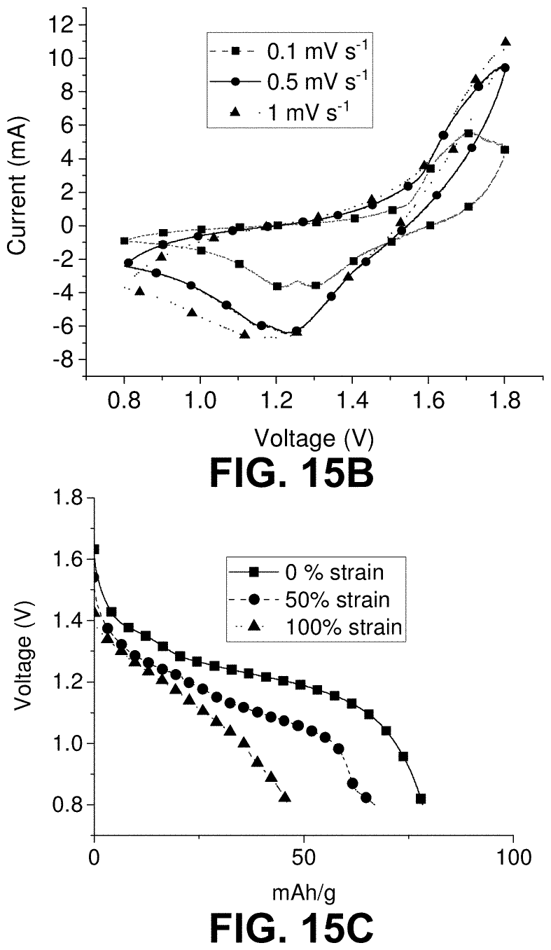

In some embodiments encapsulation 18 comprises a three-dimensional structure (see e.g. FIG. 14). In some such embodiments encapsulation 18 may be fabricated by a heat pressing process which uses one or more molds designed to produce the desired three-dimensional structure. The mold may comprise an aluminum mold. The mold may be lubricated (e.g. using a silicone lubricant deposited on the mold). Once the mold is lubricated, SIBS grains may be deposited into a cavity of the mold. Encapsulation 18 may then be heat pressed at a set temperature (e.g. about 200° C.) and set pressure (e.g. about 5 bar) for a set amount of time (e.g. about 5 minutes). In some embodiments, such temperature, pressure and/or time need not be set and can vary. The mold may be cooled down to room temperature before the SIBS layer is peeled off.

### Example Assembly of Electrochemical Cell

The various components described herein may be layered and/or assembled together to form an electrochemical cell 10. Advantageously, adjacent components of cell 10 may be bonded together using a bonding solution comprising a non-polar polymer which is found in both of the adjacent components and/or a solvent capable of dissolving the non-polar polymer which is common to both of the adjacent components. For example, adjacent components of cell 10 which both comprise SIBS may be bonded together using a solution which comprises SIBS dissolved in toluene. Additionally, or alternatively, such adjacent components may be bonded together using the solvent (e.g. toluene) alone.

By dissolving the common non-polar polymer(s) (e.g. SIBS) along an interface formed between the adjacent components, the bonding solution effectively entangles the polymer chains found in each of the individual components across the interface thereby creating a single bonded section of cell 10 (see e.g. FIG. 18 which shows entangled polymer chains crossing some of the interfaces between adjacent components of cell 10). Pluralities greater than two of adjacent components of cell 10 may be similarly bonded using a bonding solution comprising a non-polar polymer which is found in both of the adjacent components and/or a solvent capable of dissolving the non-polar polymer which is common to the plurality of adjacent components. If all of the components of the cell, including encapsulation 18, comprise a common non-polar polymer, a cell 10 having common polymer chains entangled across all layers of cell 10 (including encapsulation 18) can be produced after bonding of the different components as described herein. Such cell would advantageously exhibit uniform deformation characteristics between layers of the cell upon mechanical excitation of the cell (e.g. bending, twisting, stretching, etc.) thereby making the cell, for example, resistant to delamination of the various layers that make up the cell.

For example, if anode 13 and separator 17 both comprise SIBS, anode 13 and separator 17 may be bonded together by applying a bonding solution (e.g. a solution comprising SIBS and toluene, toluene alone, etc.) along an interface formed between anode 13 and separator 17. Once bonded together, common polymer chains may become entangled between anode 13 and separator 17. Cathode 15 (which also comprises SIBS in this example) may then be bonded on an opposite side of separator 17 by applying the solution along an interface formed between cathode 15 and separator 17. Once bonded together, common polymer chains may be entangled between cathode 15 and separator 17.

In some embodiments components are bonded sequentially together (e.g. two at a time). In some embodiments a plurality (e.g. a plurality of greater than two) of components are bonded together concurrently (e.g. both electrodes 12 are concurrently bonded to separator 17).

In some embodiments components may be fabricated directly onto other components of cell 10. For example, an electrode 12 may be fabricated directly on a film which is part of encapsulation 18 (e.g. current collector 14 and anode 13 may be fabricated on a SIBS film which will form one layer of encapsulation 18).

In some embodiments one or more components (e.g. electrodes 12, separator 17, etc.) may be cut into a desired shape prior to layering/assembly of the components.

### Experimental Results

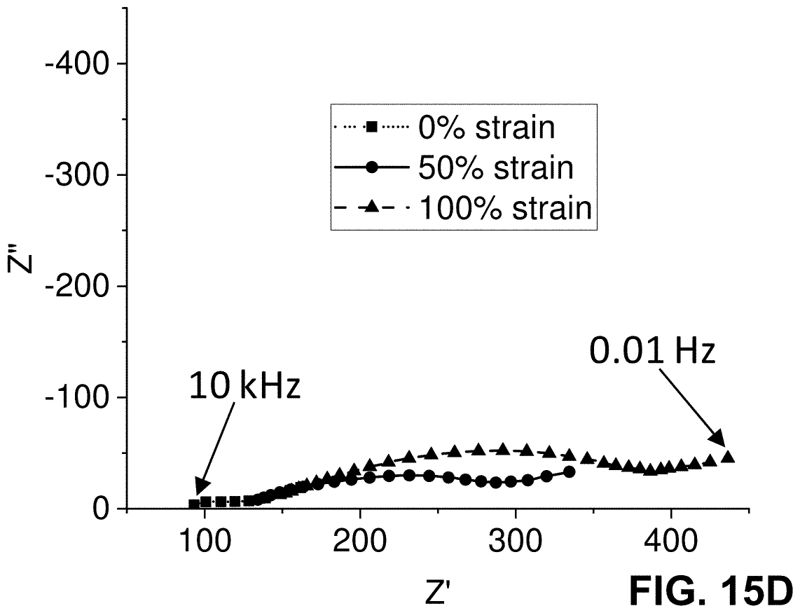

FIGS. 15A to 15F graphically illustrate example electrochemical performance parameters of cell 10 under various mechanical loading and environmental conditions.

FIG. 15A illustrates example voltage profiles of the cell when being discharged at different current rates. FIG. 15B illustrates example cycling voltammetry of the cell at different voltage scanning rates. FIG. 15C illustrates example voltage discharge profiles of the cell at different states of strain. FIG. 15D illustrates example electrochemical impedance spectroscopy (EIS) measurements from 0.01 Hz to 10 kHz at different states of strain of the cell. FIG. 15E illustrates voltage discharge profiles (in resting state) of the cell before and after being stretched for 50, 100, and 150 cycles at 100% strain. FIG. 15F illustrates specific discharge capacity and columbic efficiency of the first 500 charge and discharge cycles.

### Example Applications

In some example cases cell 10 is embedded within a wearable device. Embedded cell 10 may power one or more sensors (e.g. location sensors, heart rate sensors, temperature sensors, etc.), controllers, output devices (e.g. display screens, LEDs, speakers, etc.) and/or any other suitable electronic device. Cell 10 may advantageously be embedded within a portion of the wearable device that is subject to repeated stretching, twisting, bending, etc.

For example, cell 10 may be embedded within a stretchable fabric used to make a garment (e.g. a shirt, trousers, tights, yoga pants, jacket, etc.). Advantageously, the inventors have discovered that such garments could be repeatedly washed without affecting performance of cell 10 (e.g. no leaking of electrolyte solution or delamination of cell 10). “Repeatedly washed” may mean repeatedly washing a garment in a commercial (or residential) washing machine for at least:
23 washing cycles (e.g. about 36.5 hours);
using a water temperature of between about 15° C. and 70° C.; and/or
using detergents with a pH in the range of about 7 (e.g. a basic detergent) to 10 (e.g. a high-alkaline detergent).

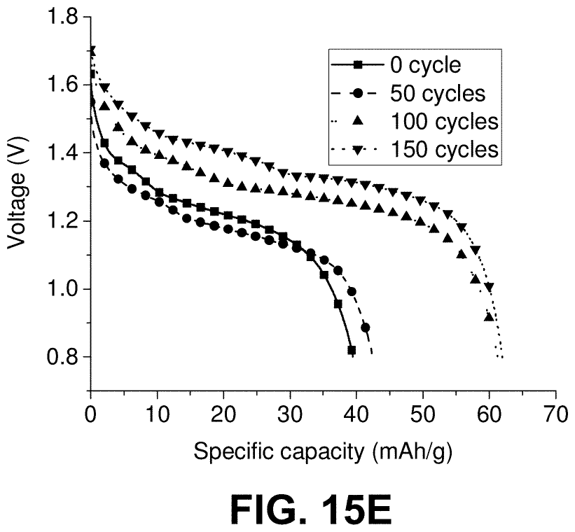

FIG. 16 graphically illustrates an example comparison of discharge capacity of a cell 10 that has never been washed and a cell 10 that has been washed 23 times. In some cases a garment with an embedded cell 10 as described herein may be washed at least 70 times without deleterious degradation of the performance characteristics of cell 10.

Given the water-proof properties of encapsulation 18 and cell 10 generally, cell 10 may be embedded in garments which may be subject to contact with large amounts of water such as raincoats, rain pants, ski pants, wet-suits, etc.

As another example, cell 10 may be embedded within a watch strap to reliably power a watch despite the strap repeatedly being stressed (e.g. stretched, twisted, exposed to liquids (e.g. water, etc.) and/or the like.

Additionally, or alternatively, cell 10 may be embedded within flexible displays, artificial electronic skins and/or the like.

In some example cases cell 10 may be used as a sensor to detect mechanical excitations.

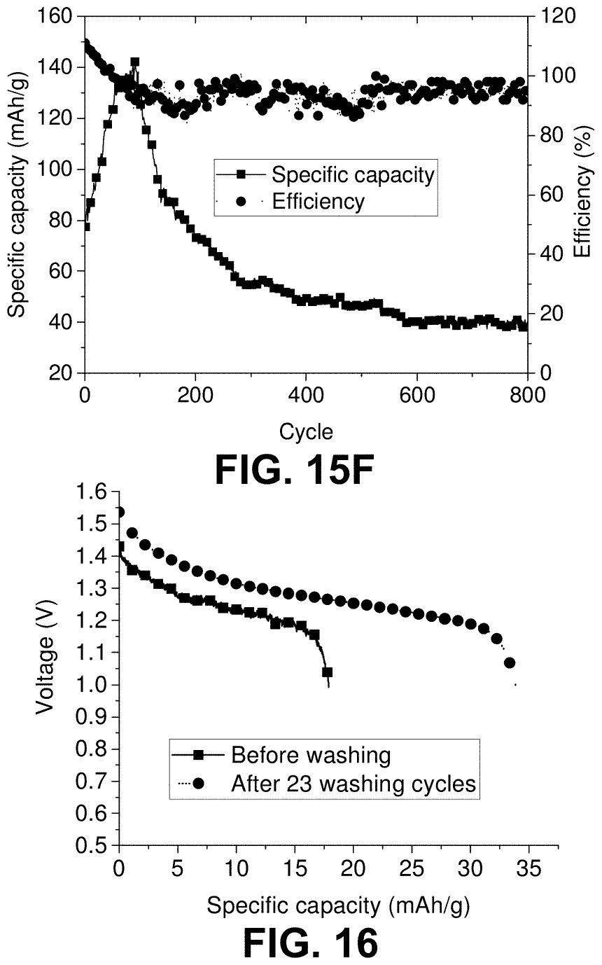

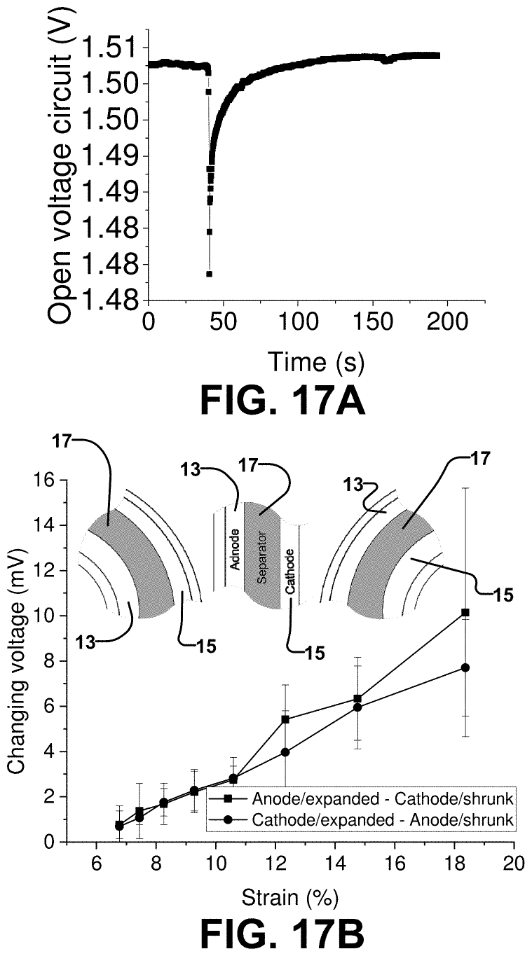

Cell 10 may comprise an open circuit voltage that is typically stable. Upon bending of cell 10 (e.g. cell 10 is subject to some level of strain (e.g. a strain of 18.3%), the open circuit voltage typically drops quickly and then slowly recovers to its original value after 100 seconds. FIG. 17A illustrates an example open circuit voltage response upon cell 10 being bent. The drop in open circuit voltage is typically small (e.g. about 15 mV at 18.3% strain) and does not typically have a deleterious affect on the performance of cell 10 as a power source. However, this voltage drop is sufficient to enable cell 10 to be used as a sensor of mechanical excitation (e.g. strain). The inventors have also found that the open circuit voltage does not increase upon cell 10 being bent.

Without being limited to a particular theory of operation, the inventors believe that the rapid fall of the open circuit voltage upon experiencing strain accompanied by a slow recovery of the open circuit voltage may come from the fast changing of double layer capacitance that forms between the electrodes and electrolyte immediately after the cell is bent, followed by a slow ion reorganization to establish a new dynamic equilibrium at the electrode interface. The decrease of the voltage magnitude regardless of the bending direction may be attributed to the non-symmetric geometry of the cell, where the positive (e.g. electrode 12+ comprising MnO₂) and negative (e.g. electrode 12− comprising Zn) electrodes always expose a positive charge and negative charge, respectively. The electron flux, therefore, may only be able to travel from the negative to positive electrode, thereby inducing the voltage reduction.

FIG. 17B illustrates example peaked voltage responses as cell 10 is bent in either direction.

In some cases cell 10 may re-charge itself at least partially (i.e. accumulate charge without application of an external power source). Without being limited to a particular theory of operation, the inventors have found that in some cases mechanically exciting (e.g. stretching, twisting, bending, etc.) cell 10 may result in a level of charge of cell 10 increasing. In one example case, a cell 10 that was subjected to a deep discharge regained charge upon being mechanically excited a few times (e.g. less than 10 times, less than 20 times, etc.). Such cell 10 could then be discharged again. In one case, after such a cell 10 was deeply discharged and then charged again by mechanical excitation, the cell 10 was discharged again at about 0.2 mA for an amount of time (e.g. about 200 seconds).

### Example Alternative Polymer Structure

One or more components of the cell have been described above as comprising a non-polar polymer in some embodiments. However, this is not mandatory in all cases. In some embodiments such non-polar polymer may be replaced with a polymer composition. Substituting a polymer composition for a non-polar polymer preferably does not affect performance parameters (e.g. stretchability, moisture permeability, operable voltage range, operable current range, etc.) of the cell.

The polymer composition may comprise a host polymer. The host polymer may be any known or future discovered polymer. The host polymer is preferably stretchable. In some embodiments the host polymer comprises a polymer having an elongation at break of more than a threshold value. In some embodiments the threshold value is at least 100%. In some embodiments the threshold value is at least 50%.

The polymer composition may also comprise one or more additives. The one or more additives may improve performance characteristics of the polymer composition. For example, the one or more additives may lower moisture permeability of the polymer composition. Lowering moisture permeability, as described elsewhere herein, advantageously may permit the cell to be repeatedly washed, may reduce an evaporation rate of the electrolyte solution thereby increasing a life span of the cell and/or the like. As another example, the one or more additives may increase rigidity of the polymer composition. Increasing rigidity may advantageously facilitate fabrication of components of the cell using the polymer composition (e.g. the polymer composition has the necessary structural integrity to be able to be fabricated into a desired structure). Typically rigidity is not increased to a point that the host polymer is no longer stretchable (e.g. the polymer composition maintains a desired elongation at break).

The one or more additives may comprise polymers or non-polymers.

In some embodiments the one or more additives comprise one or more of the group consisting of: Polyvinylidene Chloride (“PVDC”); Low-Density Polyethylene (“LDPE”); Polypropylene (“PP”); Polytetrafluoroethylene (“PTFE”); Polyvinyl Chloride (“PVC”); Fluorinated ethylene propylene (“FEP”); Polyethylene Naphthalate (“PEN”); Graphene; reduced-Graphene Oxide (“rGO”); clay; and a clay-based material.

Different components of cell 10 may be made with the same or different polymer compositions.

In some embodiments, at least two adjacent components (e.g. current collector 14 and anode 13, anode 13 and separator 17, separator 17 and cathode 15, cathode 15 and current collector 16, current collector 16 and encapsulation 18, current collector 14 and encapsulation 18, separator 17 and encapsulation 18, etc.) of cell 10 comprise a common polymer composition.

In some embodiments three or more of the components (e.g. three or more of anode 13, current collector 14, cathode 15, current collector 16, separator 17 and encapsulation 18) comprise a common polymer composition. In some embodiments all components (e.g. anode 13, current collector 14, cathode 15, current collector 16, separator 17 and encapsulation 18) of cell 10 comprise a common polymer composition.

For the purposes of this application, two polymer compositions are “common polymer compositions” if they are identical in composition or if they comprise at least one polymer that is common to both compositions.

As described elsewhere herein in relation to components of the cell which comprise non-polar polymers, different components of the cell which comprise a common polymer composition may be bonded together by entangling polymers across interfaces formed between the components which are to be bonded together.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A stretchable electrochemical cell, the cell comprising:
an anode;
a cathode;
an ionically permeable separator positioned between the anode and the cathode;
a first current collector electrically coupled to the anode; and
a second current collector electrically coupled to the cathode;
an encapsulation layer which at least partially encloses the anode, cathode, separator and first and second current collectors;
wherein the encapsulation layer and the first current collector each comprise a common non-polar polymer, the common non-polar polymer entangled across an interface between the encapsulation layer and the first current collector; and
wherein the encapsulation layer, the second current collector each comprise a second common non-polar polymer, the second common non-polar polymer entangled across an interface between the encapsulation layer and the second current collector.

2. The cell of claim 1 wherein:
the anode comprises the common non-polar polymer and the common non-polar polymer is entangled across an interface between the anode and the first current collector; and
the cathode comprises the second common non-polar polymer and the second common non-polar polymer is entangled across an interface between the cathode and the second current collector.

3. The cell of claim 1 wherein the common non-polar polymer and the second common non-polar polymer are the same.

4. The cell of claim 1 wherein the encapsulation layer fully encloses the separator, the anode and the cathode and partially encloses the first and second current collectors, leaving contact portions of the first and second current collectors outside of the encapsulation layer for interfacing other electronics.

5. The cell of claim 1 wherein the common non-polar polymer and the second common non-polar polymer have a moisture permeability of less than 80×10⁻¹⁰ cm³·cm/(cm²·s·cmHg)±10%.

6. The cell of claim 5 wherein a presence of the common non-polar polymer and the second common non-polar polymer in the encapsulation layer and the low moisture permeability of the common non-polar polymer and the second common non-polar polymer provide the cell with the ability to withstand repeated washing of the cell while maintaining electrical performance characteristics of the cell.

7. The cell of claim 1 wherein the common non-polar polymer and the second non-polymer polymer each comprises a polymer from the group consisting of: poly(styrene—isobutylene—styrene); poly(styrene-isoprene-styrene); poly(styrene-butadiene-styrene); Ecoflex™; polydimethylsiloxane (PDMS); poly(ethylene-vinyl acetate); polyurethane; butyl rubber; hydrogenated nitrile butadiene rubber; and polyethylene.

8. The cell of claim 3 wherein the common non-polar polymer and the second common non-polar polymer comprise poly(styrene—isobutylene—styrene) (SIBS).

9. The cell of claim 1 wherein the first and second current collectors comprise at least one carbon allotrope.

10. The cell of claim 9 wherein the at least one carbon allotrope comprises one or more of the group consisting of: graphite; graphene; carbon powders; acetylene black; carbon nanotubes; and carbon nanofibers.

11. The cell of claim 6 wherein a presence of the common non-polar polymer in the first current collector and the second common non-polar polymer in the second current collector provides the first and second current collectors with a stretchability greater than 100% strain±10%.

12. The cell of claim 1 wherein one or both of the anode and the cathode comprises one or more from the group consisting of: lithium; sodium; potassium; silicon; germanium; aluminum; magnesium; zinc; gallium; arsenic; silver; indium; tin; lead; and bismuth.

13. The cell of claim 3 wherein the separator comprises the same common non-polar polymer.

14. The cell of claim 1 wherein the cell is rechargeable by applying a plurality of mechanical excitations to the cell.

15. The cell of claim 14 wherein the plurality of mechanical excitations comprises at least one of stretching the cell, bending the cell and twisting the cell.

16. A method of fabricating the cell of claim 1, the method comprising at least one of:
dissolving the common non-polar polymer at least partially at the interface between the encapsulation layer and the first current collector and allowing a solvent of the solution to evaporate, thereby entangling the common non-polar polymer across the interface between the encapsulation layer and the first current collector and dissolving the second common non-polar polymer at least partially at the interface between the encapsulation layer and the second current collector and allowing a solvent of the solution to evaporate, thereby entangling the second common non-polar polymer across the interface between the encapsulation layer and the second current collector;
applying heat and pressure to the common non-polar polymer at the interface between the encapsulation layer and the first current collector to thereby entangle the common non-polar polymer across the interface between the encapsulation layer and the first current collector and applying heat and pressure to the second common non-polar polymer at the interface between the encapsulation layer and the second current collector to thereby entangle the second common non-polar polymer across the interface between the encapsulation layer and the second current collector.

17. The method of claim 16 wherein the method comprises dissolving the common non-polar polymer at least partially at the interface between the encapsulation layer and the first current collector and allowing a solvent of the solution to evaporate, thereby entangling the common non-polar polymer across the interface between the encapsulation layer and the first current collector and dissolving the second common non-polar polymer at least partially at the interface between the encapsulation layer and the second current collector and allowing a solvent of the solution to evaporate, thereby entangling the second common non-polar polymer across the interface between the encapsulation layer and the second current collector and wherein the solvent comprises one or more of the group consisting of: toluene; chloroform; dichloromethane; and trichloroethylene.

18. The method of claim 16 wherein fabricating the separator comprises using a solvent induced phase separations (SIPS) method, the SIPS method comprising:
dissolving the non-polar polymer in a solution comprising a solvent and a nonsolvent;
evaporating the solvent from the solution;
growing and coalescencing nonsolvent-rich droplets; and
removing the nonsolvent droplets.

19. The method of claim 18 wherein the nonsolvent comprises one or more of the group consisting of: hexane; acetone; butanol; 2-propanol; tetrahydrofuran (THF); dimethyl sulfoxide (DMSO); methanol and water.

20. A stretchable electrochemical cell, the cell comprising:
an anode;
a cathode;
an ironically permeable separator between the anode and the cathode;
a first current collector electrically coupled to the anode; and
a second current collector electrically coupled to the cathode;
an encapsulation layer which at least partially encloses the anode, cathode, first and second current collectors and the separator;
wherein each of the anode, the cathode, the separator, and the first and second current collectors comprise a corresponding non-polar polymer;
wherein the encapsulation layer comprises a styrene-based non-polar polymer.

21. The cell of claim 20 wherein the styrene-based non-polar polymer is SIBS.

22. The cell of claim 20 wherein the styrene-based non-polar polymer in the encapsulation layer and the non-polar polymer in the first current collector comprise a common non-polar polymer.

23. The cell of claim 22 wherein the styrene-based non-polar polymer in the encapsulation layer and the non-polar polymer in the second current collector comprise a second common non-polar polymer.

24. The cell of claim 23 wherein:
the common non-polar polymer is entangled across an interface between the encapsulation layer and the first current collector; and
the second common non-polar polymer is entangled across an interface between the encapsulation layer and the second current collector.

25. The cell of claim 24 wherein the common no-polar polymer and the second common non-polar polymer are the same.
